(19) United States
(12) Patent Application Publication
(10) Pub. No.: US 2025/0026461 A1
(43) Pub. Date: Jan. 23, 2025

(54) METHOD AND DEVICE FOR CONTROLLING AN UNDERWATER VEHICLE MOVING ALONG A TRAVEL TRAJECTORY

(71) Applicant: FNV IP B.V., Leidschendam (NL)

(72) Inventors: Chad Allen PASTOR, Lafayette, LA (US); Eric Carroll LISSARD, New Iberia, LA (US); Igor Konrad Dorrestijn, Leidschendam (NL)

(21) Appl. No.: 18/355,328

(22) Filed: Jul. 19, 2023

(51) Int. Cl. B63G 8/00; B63G 8/14; B63G 8/39; B63G 8/42; G01C 21/20

(52) U.S. Cl. CPC B63G 8/001; B63G 8/14; B63G 8/39; B63G 8/42; G01C 21/20; B63G 2008/002

(57) ABSTRACT

A method for controlling an underwater vehicle moving along a travel trajectory is disclosed. The movement of the underwater vehicle is dependent on a vessel physically connected thereto. The method is performed by a processor and comprises the steps of: obtaining a topography of an underwater region where the underwater vehicle travels; obtaining a predicted trajectory of the underwater vehicle; deriving a relationship between the predicted trajectory of the underwater vehicle and a seafloor represented by the topography of the underwater region; and controlling the underwater vehicle based on the determined relationship; wherein the topography of the underwater region is linkable to a coordinate system of the travel trajectory of the underwater vehicle. Unlocking insights from Geo-Data, the present invention further relates to improvements in sustainability and environmental developments: together we create a safe and liveable world.

### FIELD OF THE INVENTION

The present disclosure generally relates to the field of underwater vehicles, and more specifically to a method and device for controlling an underwater vehicle moving along a travel trajectory. Unlocking insights from Geo-Data, the present invention further relates to improvements in sustainability and environmental developments: together we create a safe and liveable world.

### BACKGROUND OF THE INVENTION

Marine site characterization, asset integrity assessment, and environmental surveying often involve the deployment and operation of various underwater vehicles and devices including autonomous underwater vehicles, AUVs, remotely operated vehicles, ROVs, and devices towed behind a surface vessel, such as a towfish. These underwater or submerged devices are designed to operate underwater, to perform diverse underwater tasks and to gather important data about the marine environment.

Those underwater vehicles or devices, while operating underwater, can face varying and sometimes challenging environments including unpredictable seabed, shipwrecks, geo hazards, fishing gear, reef areas, environmental hard ground, and other types of hazards.

It is therefore necessary for these underwater devices to adapt its traveling trajectory where necessary, so as to avoid crash of the device into obstacles, which may result in loss of equipment and potential health and safety issues as well as environmental issues.

AUVs are autonomous vehicles that operate independently without a physical connection to a surface vessel. AUVs can carry a variety of sensors and instruments for tasks such as bathymetric mapping, oceanographic data collection, environmental monitoring, and marine research.

An AUV's knowledge of the seabed around it comes from bathymetry data collected before the dive which is used in mission planning to predict the optimal height for the AUV along the planned route. An AUV can adjust its travel route or trajectory where needed, based on data collected by its sensors, instead of relying on control from another vehicle.

ROVs are connected to the surface vessel by a tether, which provides power and control signals. Controlling of the ROVs is performed by human operators from the surface using a tether or umbilical cord.

Towed devices may include sidescan sonar, various configurations of magnetometer and/or array, moving water velocity profiler, cameras, sediment grab systems and mammal passive listening devices. These devices are typically towed behind a surface vessel and are connected to it by a cable or tow line. They are passive devices that rely on the motion of the towing vessel for propulsion.

A ROV is typically more flexible and adaptable compared to an AUV. Unlike AUVs, which follow pre-programmed mission plans, ROVs are remotely operated by human operators who have direct control over their movements and navigation in real-time.

ROV operations often involve more dynamic and complex scenarios, where adjustments and adaptations to the navigation route may be necessary. The operator can make on-the-spot decisions based on the real-time observations and the specific objectives of the mission.

ROVs are equipped with live video feeds and sensors that provide feedback to the operator, allowing them to assess the current conditions, obstacles, or targets of interest. The operator can then adjust the ROV's navigation, change its direction, speed, and depth, as well as perform precise maneuvers as needed.

In situations where unexpected conditions or obstacles are encountered, the operator can modify the navigation route or implement alternative approaches to overcome challenges. For example, the operator may need to navigate around underwater structures, adjust the ROV's position to capture detailed visual inspection data, or respond to changes in environmental conditions.

The operator's expertise and decision-making play a crucial role in navigating the ROV effectively and achieving the mission objectives.

Similarly, adjustment or adaption of the travel trajectory or route of a towed device is also performed by way of human monitoring the path of the device and checking whether it may crash into an obstacle or ground. This is done by an operator reviewing a hazard map, real time multibeam data, real time camera data and so on. Then decisions are made by the human operator so as to raise or lower the altitude of the underwater device or fly left or right of the hazard in real time.

Depth control of a towed device is managed by a winch at the surface vessel. An operator lets cable out to put the towed device deeper and pull cable in to make the towed device rise. The response time can be long depending on the speed of the winch and the length of the cable out. As for the ROV, its depth is controlled mostly be thrusters located on the ROV.

For both the towed device and the ROV, the conventional depth control relies on operational activity and interference from humans, which is costly in terms of human resources and may also unduly increase the response time, causing undesired consequences.

In consideration of the above, it is desirable that a method for controlling an underwater vehicle moving along a travel trajectory is available which can reduce human operations and reduce the risk of the underwater vehicle being crashed onto an obstacle.

### BRIEF SUMMARY OF THE INVENTION

According to one aspect of the present disclosure, there is presented a method for controlling an underwater vehicle moving along a travel trajectory, movement of the underwater vehicle being dependent on a vessel physically connected thereto, the method performed by a processor and comprising the steps of:
obtaining a topography of an underwater region where the underwater vehicle travels;
obtaining a predicted trajectory of the underwater vehicle;
deriving a relationship between the predicted trajectory of the underwater vehicle and a seafloor represented by the topography of the underwater region; and
controlling the underwater vehicle based on the determined relationship;
wherein the topography of the underwater region is linkable to a coordinate system of the travel trajectory of the underwater vehicle.

The present disclosure is based on the insight that the risk of an underwater vehicle being crashed onto an obstacle can be reduced by controlling the underwater vehicle based on constantly calculated hazardous intersection of the underwater equipment and possible marine hazards.

This is realised by obtaining both a topography of an underwater region where the underwater vehicle travels and a predicted trajectory of the underwater vehicle. The obtained topography of an underwater region where the underwater vehicle travels and the predicted trajectory of the underwater vehicle are compared to find a relationship between the predicted trajectory of the underwater vehicle and a seafloor represented by the topography of the underwater region. The derived relationship gives an indication as to if any risk of the underwater vehicle hitting or collide with an obstacle exists. The underwater vehicle is then controlled based on the derived relationship.

The topography of the underwater region is linkable to the coordinate system of the travel trajectory of the underwater vehicle, which makes it possible to derive a relationship between the predicted trajectory of the underwater vehicle, both in its current and future positions, and the seafloor. The derived relationship is used for the control of the underwater vehicle.

It will be understood by those skilled in the art that the “seafloor represented by the topography of the underwater region” as used in the present disclosure refers to a surface of an underwater region which might come into contact with the underwater vehicle when it travels too close to the surface. The seafloor represented by the topography of the underwater region therefore comprises any shipwrecks, geo hazards, fishing gear, reef areas or other interested targets on the seafloor.

The method tracks the underwater device physically connected with a vessel in a three dimensional, 3D, underwater space in real time and uses a predictive model to update a forward 3D trajectory of the underwater device, which allows automatic control of the travel trajectory of the underwater vehicle and effectively reduces the risk of collision of the underwater vehicle. Moreover, the method of the present disclosure reduces human operations largely as no constant monitoring and checking of the path of the device is needed.

In an example of the present disclosure, the topography of the underwater region is linkable to a coordinate system of the travel trajectory of the underwater vehicle and obtained based on at least one of:
a measurement by a multibeam system on the vessel connected to the underwater vehicle;
a sonar system provided on the underwater vehicle;
an optical distance measuring device provided on the underwater vehicle; and historical seafloor information of the underwater region.

As can be understood by those skilled in the art, both the vessel and the underwater vehicle can be equipped with various measurement devices, such as a sonar system or a distance sensor. Such measurement devices can be used to obtain the topography of the underwater region where the underwater vehicle travels in real time. When historical seafloor information of the underwater region is available, for example from previous projects conducted in the same underwater region, such information may also be used in forming the topography of the underwater region.

In an example of the present disclosure, the predicted trajectory of the underwater vehicle is obtained based on a pre-programmed route or via an extrapolation of a current travel trajectory of the underwater vehicle.

The predicted trajectory of the underwater vehicle is obtained based on available information, which can include a pre-programmed route of the underwater vehicle or a current path of the underwater vehicle. Such information allows the trajectory of the underwater in a subsequent or future time period to be predicted.

In an example of the present disclosure, the pre-programmed route is obtained from a mission planner or by flying the underwater vehicle over defined coordinates.

In another example of the present disclosure, predicted trajectory of the underwater vehicle is obtained based on at least one of a target distance to the seafloor, a current position of the underwater vehicle, and a maximum and a minimum altitude above the seafloor.

Depending on the specific application of the underwater vehicle, one or more of the above listed parameters can be used to derive the predicted trajectory of the underwater vehicle.

In an example of the present disclosure, the predicted trajectory of the underwater vehicle comprises a plurality of points, the determining step comprises the steps of:
calculating altitude differences between multiple points of the predicted trajectory of the underwater vehicle and corresponding points on the seafloor of the underwater region;
determining a relationship between each of the altitude differences and a target altitude range.

As can be contemplated by those skilled in the art, the predicted trajectory of the underwater vehicle may comprise a plurality of geographical points represented by respective coordinates of each point along the predicted trajectory. The seafloor of the underwater region where the underwater vehicle travels as illustrated in the topography of the underwater region can also be defined using coordinates of a number of points.

An altitude difference between a point on the predicted trajectory of the underwater vehicle and a corresponding point on the seafloor is obtained therefore by calculating the difference therebetween. This difference represents a relationship between the predicted position of the underwater vehicle and the seafloor.

It can be contemplated by those skilled in the art for some applications the travel trajectory of the underwater vehicle is expected to fall within a target altitude range above the seafloor. In this case, the calculated altitude differences for the plurality points on the predicted trajectory of the underwater vehicle are compared to the target altitude range, which gives the relationship between the predicted position of the underwater vehicle and the seafloor. The travel trajectory of the underwater vehicle can be adjusted or adapted based on determined relationship.

In an example of the present disclosure, the target altitude range is defined by a maximum altitude and a minimum altitude, the determining step comprises determining that the altitude differences are smaller than the maximum altitude and larger than the minimum altitude, the controlling step comprises allowing the underwater vehicle to travel along the current path.

This is the situation where there is no risk of the underwater vehicle being collide into any obstacle, therefore it is allowed to follow its current path with no adjustment of its trajectory needed.

In an example of the present disclosure, the target altitude range is defined by a maximum altitude and a minimum altitude, the determining step comprises determining that one or more of the altitude differences is larger than the maximum altitude; the controlling step comprises decreasing the altitude of the one or more points, of the predicted trajectory of underwater vehicle, with altitude differences larger than the maximum altitude.

This shows that the underwater vehicle is travelling too high above the seafloor. Therefore, the depth of the underwater vehicle is increased or the altitude of the underwater vehicle is decreased so that the underwater vehicle can travel closer to the seafloor or any other objects that is under investigation by the underwater vehicle.

In an example of the present disclosure, the target altitude range is defined by a maximum altitude and a minimum altitude, the determining step comprises determining that one or more of the altitude differences is smaller than the minimum altitude; the controlling step comprises changing route of the underwater vehicle or stopping the underwater vehicle.

This shows that the underwater vehicle is traveling close to the seafloor or an obstacle on the seafloor, such as shipwrecks, therefore its route is changed or the underwater vehicle is stopped so as to avoid a collision with the obstacle.

In an example of the present disclosure, the underwater vehicle is a towed vehicle, the control step is performed via an in-or out-movement of a cable connecting the towed vehicle to the vessel.

The depth of the towed device is managed by a winch at the surface vessel, and the depth can be adjusted by letting cable out or pulling cable in. The predictive nature of the method of the present disclosure allows the response time of controlling the towed device to be shortened, which is advantageous in securing the safe operation of the towed device.

In an example of the present disclosure, the underwater vehicle is a remotely operated underwater vehicle, ROV, the control step is performed by sending a command to the ROV, via a tether connecting the ROV to the vessel.

In terms of being physically connected to a surface vessel, the ROV is similar to a towed device. However, the control of the movement of the ROV is performed via the tether connecting the ROV to the vessel. Commands can be sent through the tether to thrusters of the ROV to push the ROV around and up and down.

In an example of the present disclosure, the predicted trajectory of the underwater vehicle comprises a plurality of points, the determining step comprises the steps of:
calculating a slope of first and a second point following a current point on the predicted trajectory of the underwater vehicle;
determining that the slope is larger than an upslope threshold;
the controlling step comprises replacing an altitude of the second point following the current point on the predicted trajectory of the underwater vehicle with an altitude calculated based on the upslope threshold.

In an alternative example of the present disclosure, the predicted trajectory of the underwater vehicle comprises a plurality of points, the determining step comprises the steps of:
calculating a slope of first and a second point following a current point on the predicted trajectory of the underwater vehicle;
determining that the slope is smaller than a downslope threshold;
the controlling step comprises replacing an altitude of the second point following the current point on the predicted trajectory of the underwater vehicle with an altitude calculated based on the downslope threshold.

The above examples explain how to automatically adapt the travel trajectory of the underwater vehicle based on the predicted trajectory comparing with an expected trajectory. The adaptation or adjustment of the travel trajectory of the underwater vehicle is performed in a preventive manner, which helps to avoid future hazard that the underwater vehicle will encounter when it travels along its current path. This is very important as this will help to significantly reduce the human interference required while ensuring secure operation of the underwater vehicle.

In a second aspect of the present disclosure, there is presented a device for controlling an underwater object moving along a travel trajectory, movement of the underwater object being dependent on a vessel connected thereto, the device comprising a processor configured to perform the method according to the first aspect of the present disclosure.

In a third aspect of the present disclosure, a computer product is provided, the computer product comprising a computer readable storage medium storing instructions which, when executed on at least one processor, cause the at least one processor to carry out the method according to the first aspect of the present disclosure.

The above mentioned and other features and advantages of the disclosure will be best understood from the following description referring to the attached drawings. In the drawings, like reference numerals donate identical parts or parts performing an identical or comparable function or operation.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 schematically illustrates, in a flow chart type diagram, an embodiment of a method 10 for controlling an underwater vehicle moving along a travel trajectory according to the present disclosure.

FIG. 2 is a diagram schematically illustrating an embodiment of using the method of present disclosure to control the travel trajectory of an underwater vehicle.

### DESCRIPTION OF ILLUSTRATIVE EMBODIMENTS

Embodiments contemplated by the present disclosure will now be described in more detail with reference to the accompanying drawings. The disclosed subject matter should not be construed as limited to only the embodiments set forth herein. Rather, the illustrated embodiments are provided by way of example to covey the scope of the subject matter to those skilled in the art.

In the present disclosure, the terms “route”, “trajectory” and “path” are used interchangeably, the phrases “travel route”, “navigation route”, and “travel trajectory” are used interchangeably.

In the following description, the term “underwater object”, “underwater device” or “underwater vehicle” is used to refer to a device which travels in an underwater or submerged position and the movement of the device is dependent on a vessel physically connected thereto.

According to the method of the present disclosure, a live topography or map of the seafloor of a region where the underwater travels, including obstacles, is created by using data acquired in real time and/or available information. The method further tracks underwater position, altitude, or depth of the underwater vehicle, and computes a real time a trajectory of the underwater vehicle using a predictive model. The real time trajectory of the underwater vehicle is adapted based on its relationship with the live map of the seafloor. On the other hand, the underwater vehicle is controlled automatically or manually to prevent any imminent collision.

The method therefore allows adaptation or adjustment of the travel trajectory of the underwater vehicle to be performed, completely or semi-automatically, based on a computer implemented method, instead of relying totally on human observation and checking of the marine situation.

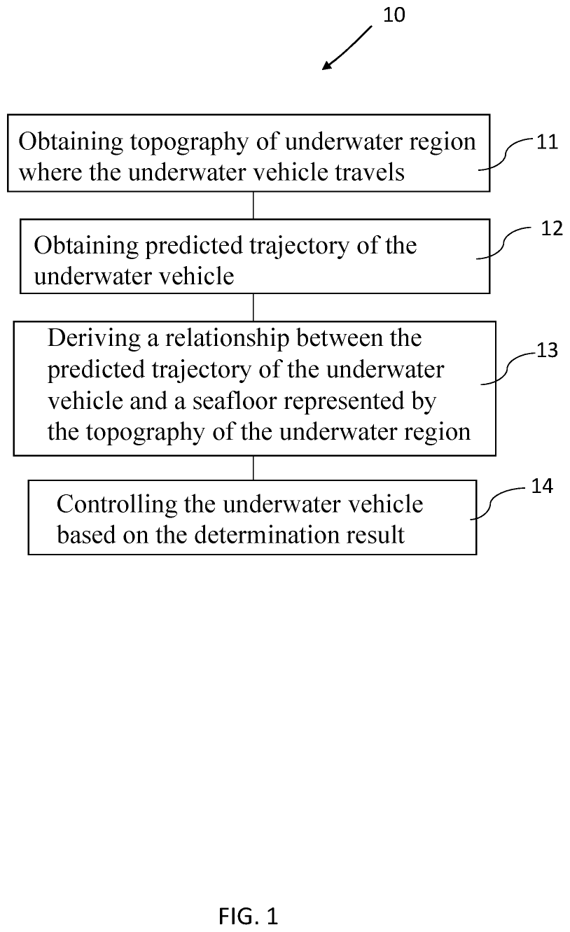

Referring to FIG. 1, in which an embodiment of a method 10 for controlling an underwater vehicle moving along a travel trajectory according to the present disclosure is schematically illustrates in a flow chart type diagram. Movement of the underwater vehicle is dependent on a vessel physically connected thereto.

At step 11, a topography of an underwater region where the underwater object travels is obtained.

This can be done by for example a multibeam on the vessel, which travels in front of the underwater vehicle. Alternatively, the map of the seafloor can be provided through such as a forward-looking sonar on the underwater vehicle or cameras/stereo cameras/lidars or on underwater vehicle.

The topography or map of the underwater region may also be obtained based on historical data, such as maps available from previous projection.

For a seafloor map to be used for path prediction of the present disclosure, the map needs to be linkable to a coordinate system of the path or trajectory of the topography.

At step 12, a predicted trajectory of the underwater object is obtained.

The path of the underwater vehicle is obtained by predicting a path of the underwater vehicle. This can be done by predicting the path of the underwater vehicle based on for example a pre-programmed route if available. Such a route may be obtained from for example a mission planner. Alternatively, when the underwater vehicle is a ROV, it can be obtained by flying the ROV over the ‘as-laid’ coordinates, or by e.g., pipeline tracking. Pipeline tracking maybe done either electromagnetic or visually.

It is also possible to obtain the predicted path by extrapolation of the current trajectory of the underwater vehicle, by for example based on current speed and location. Such method is known to those skilled in the art and will not be elaborated here.

Depending on the specific applications, the predicted trajectory of the underwater vehicle may be obtained based on at least one of a target distance to the seafloor, a current position of the underwater vehicle, and a maximum and a minimum altitude above the seafloor.

At step 13, a relationship between the predicted trajectory of the underwater vehicle and a seafloor represented by the topography of the underwater region is derived.

It can be contemplated by those skilled in the art that the predicted trajectory of the underwater vehicle comprises a plurality of points each represented by its coordinates. There are corresponding points on the seafloor. Distances between a number of points on the predicted trajectory of the underwater vehicle and corresponding points on the seafloor may be obtained by simple arithmetic calculation. This represents relying on altitude differences between the predicted trajectory of the underwater vehicle and the seafloor to find the relationship between the predicted trajectory of the underwater vehicle and the seafloor. One way of doing that is to compare the altitude difference with a target altitude range.

The target altitude range represents an altitude difference between the underwater vehicle and the seafloor which helps to prevent collision and to keep the underwater vehicle as an optimal depth or depth range, which is needed for example for the underwater vehicle to perform its tasks in a better way.

The comparison step decides if the underwater vehicle is travelling at this optimal depth (range), which will be used to perform control on the underwater vehicle subsequently at step 14.

As an alternative solution, the relationship between the predicted trajectory of the underwater vehicle and the seafloor can be determined by checking a “moving trend” of the underwater vehicle. As an example, a slope between two points along the predicted trajectory of the underwater vehicle can be calculated. This trend, when being compared to a slope threshold, will suggest whether the underwater vehicle will travel closer or further away from the seafloor, which allows the relationship between the predicted trajectory of the underwater vehicle and the seafloor to be foreseen.

Thereafter, at step 14, the underwater object is controlled based on the relationship between the predicted trajectory of the underwater vehicle and the seafloor determined at step 13.

The control may comprise for example a halt of operations of the underwater vehicle, adjustment of the course or evasion, to prevent collision, or just a warning, and no active response.

The above method is performed by a processor which may be a processor of a computing device onboard the surface vessel or the underwater vehicle itself. As an example, when the underwater device is a ROV which has a computer onboard, the method can be performed by the processor of the computer provided on the ROV. In another example, when the underwater device is a towed sensor which is not equipped with a computer, the method can be performed by the surface vessel connected to the towed sensor.

In the following, a detailed implementation of the above method of the present disclosure will be described. The method may be implemented as a software or a part of a software, such as a software module, running on a processor as discussed above.

Inputs to the software may comprise a current position of the underwater vehicle, a position of the underwater vehicle after a defined period, such as in t seconds, a seabed interval. The inputs to the software may further comprise an optimal altitude of the underwater vehicle, a maximum altitude value, and a minimum altitude value. The inputs to the software may also further comprise an upslope in degrees and a downslope in degrees.

The current position of the underwater vehicle is represented by a geographical location of the underwater vehicle. The geographical location of the underwater vehicle may be obtained in real time by relying on positioning systems integrated into the underwater device or its support vessel. The most commonly used system is the Global Positioning System, GPS.

For a GPS system, the GPS receiver on the surface vessel receives signals from satellites to determine its own location. The positioning data includes latitude and longitude coordinates and altitude. Depending on the setup, this data may be stored locally on the surface vessel, it may also be transmitted to the underwater vehicle in real-time for further use.

Those skilled in the art will understanding that the position data may also be obtained using a vertical datum based on the ellipsoid or geoidal datum (effectively tidal based). The key is that all measurements and computations are done on the same datum. For horizontal datums underwater vehicles are generally positioned by Ultra-Short Baseline, USBL, from the mother vessel or by inertial systems on the underwater vehicle.

Those skilled in the art will understand that any currently available and future-

developed technologies for determining geographical locations of an object may be used to find the current position of the underwater vehicle. Moreover, more than one positioning technologies may be used in combination to obtain more accurate position information of the underwater vehicle

As an example, in certain situations, such as deep underwater operations, additional positioning technologies like acoustic navigation systems may be used to enhance accuracy of the geographical location information of the underwater device.

The position of the underwater vehicle after a defined period, which may also be referred to as the future position of the underwater vehicle, may be obtained from the current position of the underwater vehicle and a travelling speed of the surface vessel or the underwater vehicle.

As an example, for an underwater device equipped with sensing devices and towed by the surface vessel, its position after t seconds may be computed as its current position plus the speed of the surface vessel multiplying the speed of the surface vessel. Multiple future positions of the underwater may be obtained.

The above is used to find a predicted trajectory of the underwater vehicle. The predicted trajectory of the underwater vehicle may also be obtained based on other data or measurements as discussed above, which is known to those skilled in the art and will not be elaborated here.

The predictive trajectory is then sampled at a seabed interval. The seabed interval in meters may be defined by an operator using the software implementing the method of the present disclosure. It may also be decided based on a default setting of the software.

For each sample points on the predictive trajectory, a depth or altitude value is obtained by using a real time model. The real time model comprises coordinates of the underwater vehicle and the topography of the region where the underwater vehicle is travelling.

The maximum altitude value, and the minimum altitude value define an altitude window within which the underwater vehicle should travel, and the optimal altitude of the underwater vehicle falls into this window.

The upslope and downslope define how the travel trajectory of the underwater vehicle may be adjusted based on these slopes.

In addition, the software also maintains a topography of the region where the underwater vehicle travels. The topography may be obtained from real-time multibeam data, real-time forward-looking sonar data and other data allowing the topography of the underwater region to be determined.

Alternatively, the topography may also be obtained based on predetermined digital terrain observations or historical data such as maps.

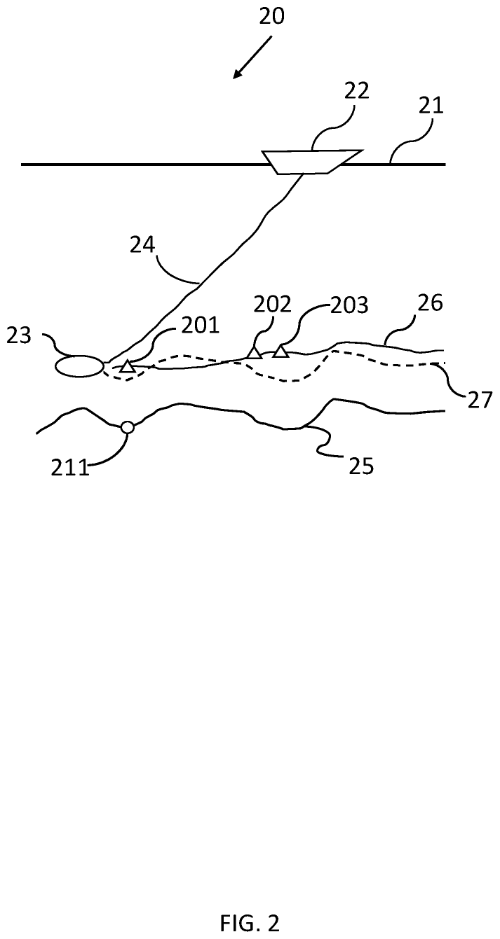

FIG. 2 is a diagram schematically illustrating an embodiment 20 of using the method of present disclosure to control the travel trajectory of an underwater vehicle.

In FIG. 2, a vessel 22 on the sea 21 tows or is physically connected to an underwater vehicle 23 by way of a cable, a winch or a tether 24. The seafloor of the region where the underwater vehicle 23 travels is indicated by a reference numeral 25. A solid line represents a predicted trajectory 26 of the underwater vehicle, and a dashed line 27 represents an optimal trajectory of the underwater vehicle.

It will be discussed in the following how the travel trajectory of the underwater vehicle 23 is controlled according to the method of the present disclosure described above.

According to an embodiment of the present disclosure, the method of the present disclosure checks if altitude differences between the predictive trajectory of the underwater vehicle and the seafloor are within an altitude window defined by a maximum altitude and a minimum altitude.

As an example, for a point 201 on the predicted trajectory 26 of the underwater device 23, a corresponding point 211 on the seafloor 25 is decided with reference to the latitude and longitude of the point. Then a difference between the point 201 on the predicted trajectory 26 of the underwater device 23 and the corresponding point 311 on the seafloor 25 is found by for example calculating an altitude difference or depth difference between the point 201 and the point 211.

The altitude or depth differences of multiple points on the predicted travel trajectory of the underwater vehicle and corresponding points on the seafloor are calculated. Then each of the altitude differences is compared with altitude window (not shown) defined by the maximum altitude and the minimum altitude, thereby deriving a relationship between the predicted trajectory of the underwater vehicle and the seafloor.

The range formed by the maximum altitude and minimum altitude covers the optimal altitude 27 of the underwater vehicle 23. It can be contemplated by those skilled in the art that the altitude range may be decided based on the applications. Having a smaller altitude range will allow the travel trajectory of the underwater vehicle to be controlled in a more precise way.

If the comparison shows that the point 201 is inside the altitude window, no operation is needed and the underwater vehicle is allowed to travel following the predicted trajectory.

If a point of the predicted trajectory is decided to be above the maximum altitude or below minimum altitude then an out of window warning is triggered, the warning can indicate a distance of the point to the current position of the underwater vehicle, by for example after a certain period of time or after a certain distance from the current position.

As an implementation, each warning may be stored at the distance above or below the altitude window.

Furthermore, the underwater vehicle is controlled to make it travel lower or higher above the seafloor. Depending on the underwater vehicle being control, this may be realised by pulling in or letting out a winch or cable connecting a towed device or by transmitting a control signal to a ROV via a tether.

It will be understood by those skilled in the art that the underwater vehicle may also be control to adapt its trajectory horizontally, that is to the left or right of its current trajectory.

Another example of determining the relationship between the predicted trajectory of the underwater vehicle and the seafloor is checking two points on the predicted trajectory of the underwater vehicle at the same time.

It is assumed that the current position of the underwater vehicle is reasonable. A slope for the subsequent two point after the current point on the predictive trajectory is calculated. The calculated slope is compared with the upslope and downslope to decide if the trajectory after the current position will allow the underwater vehicle to travel safely without any risk.

It can be contemplated by those skilled in the art that the upslope and downslope may be defined with reference to a target travelling route of the underwater vehicle and can be adjusted where necessary, so that real time topography of the seafloor is taken into consideration.

If the calculated slope is less than or equal to the upslope and greater than or equal to the downslope, it shows that the underwater vehicle is safe to follow this predicted trajectory. In this case, the underwater vehicle is allowed to travel following its current trajectory without any adjustment.

If the slope is greater than the upslope, it shows that the underwater vehicle will be travelling at a depth which is too far from the seabed or an intended target such as a pipeline on the seabed. In this case, a depth for the second point on the trajectory is calculated by using the upslope instead of the calculated slope, and the depth of the second point on the predictive trajectory is replaced with the calculated depth. This allows the route of the underwater vehicle to get adjusted such that it travels closer to the seabed.

If the calculated slope is less than the downslope, it shows that the underwater vehicle will be travelling too close to the seafloor. In this case, a depth for the second point on the trajectory is calculated using the downslope instead of the calculated slope, and the depth of the second point on the predictive trajectory is replaced with the calculated depths. This allows the underwater vehicle to travel a bit further from the seabed so as to avoid any potential collision.

The new trajectory with the updated depth for the second point is stored. It is noted that depth values are different based on upslope and downslope values.

The above procedure is repeated while the underwater vehicle is travelling, which allows the travel trajectory of the underwater to get adjusted or adapted automatically without the interference of human operators.

Another scenario is when a line connecting a previous point to the current point

intersects with a line representing the seabed, it shows that collision will happen, for example in t seconds, from the current position. In this case, a stop the operation warning is given

Still referring to FIG. 2, a slope between two points 202 and 203 on the predicted trajectory of the underwater vehicle 23 is calculated and compared with a defined upslope. It shows that the calculated slope is greater than the upslope, indicting that the underwater vehicle will be travelling too far from the seafloor if it follows the predicted trajectory.

In this case, the altitude of point 203 is recalculated by using the defined upslope, extrapolated a new altitude for the point 203. This new altitude is then used to replace the altitude for the point 203, which allows the underwater vehicle to adjust its travel trajectory so that its altitude is lowered, thereby staying closer to the seafloor and any interested target on the seafloor.

Although points 202 and 203 are illustrated as two adjacent points on the predicted trajectory of the underwater vehicle, those skilled in the art will understand the selection of points is influenced by various factors.

As an example, if prediction and adjustment is to be made for a part of the travel trajectory of the underwater vehicle which is further away from the current position of the underwater vehicle, a further second point may be chosen.

Depending on the desired accuracy of adjustment, points further away from each other may be used for lower accuracy while immediately advancement points may be used for higher accuracy. Those skilled in the art will understand adjusting the seabed interval may also influence the accuracy of adjustment.

The software can generate as an output a report summary about the future situation, such that a correct action can be taken.

All of the above are done with no or little human intervention. Therefore, the method of the present disclose enables automatic or semi-automatic trajectory adaption or adjustment based on the comparison between the predicted trajectory and the topography of the seafloor. Furthermore, the method can give warning or alter, which may be used to introduce necessary human interference on the operation of the underwater device so as to prevent any possible collision.

According to the method of the present disclosure, a ‘minimal safe distance’ from an obstacle may also be maintained. If the comparison results in the breach of the minimal safe distance, even if the underwater device would not hit the obstacle, it can be flagged as a risk and the course of the underwater vehicle can be adjusted.

The resulting actions from a collision warning or possible control over the underwater device in response to a warning are described in the following.

In some instances, the vessel has to respond to the action taken by a ROV such as e.g. adjusting the umbilical length from the vessel to the ROV. Optionally, the vessel/USV can take corresponding evasive action as the ROV, such as moving laterally in response to the ROV action.

The operation can re-adjust the course of the ROV manually. The system can self-adjust the course of the ROV to get it back on the required path, that is, back to mission plan or back to an initially extrapolated trajectory.

The system can also re-acquire the target (such as a pipeline), e.g. through visual indication, or through sensors, such as pipe-trackers. Through this detection, the ROV can be redirected towards the target and resume the operation it was originally on.

As for an underwater vehicle towed by the surface vessel via a winch, the system can order the winch and/or wing controls to automatically adjust to raise the altitude or move cross track to a avoid the hazard.

Once avoided, it will then return to normal operating altitude and survey planned line.

The invention has been described by reference to certain embodiments discussed above. It will be recognized that these embodiments are susceptible to various modifications and alternative forms well known to those of skill in the art.

Further modifications in addition to those described above may be made to the structures and techniques described herein without departing from the spirit and scope of the invention. Accordingly, although specific embodiments have been described, these are examples only and are not limiting upon the scope of the invention.

1. A method for controlling an underwater vehicle moving along a travel trajectory, movement of the underwater vehicle being dependent on a vessel physically connected thereto, the method performed by a processor and comprising the steps of:
obtaining a topography of an underwater region where the underwater vehicle travels:
obtaining a predicted trajectory of the underwater vehicle;
determining a relationship between the predicted trajectory of the underwater vehicle and a seafloor represented by the topography of the underwater region; and
controlling the underwater vehicle based on the determined relationship;
wherein the topography of the underwater region is linkable to a coordinate system of the travel trajectory of the underwater vehicle.

2. The method according to claim 1, wherein the topography of the underwater region is obtained based on at least one of:
a measurement by a multibeam system on the vessel connected to the underwater vehicle;
a sonar system provided on the underwater vehicle;
an optical distance measuring device provided on the underwater vehicle; and
historical seafloor information of the underwater region.

3. The method according to claim 1, wherein the predicted trajectory of the underwater vehicle is obtained based on a pre-programmed route or via an extrapolation of a current travel trajectory of the underwater vehicle.

4. The method according to claim 3, wherein the pre-programmed route is obtained from a mission planner or by flying the underwater vehicle over defined coordinates.

5. The method according to claim 1, wherein the predicted trajectory of the underwater vehicle is obtained based on at least one of a target distance to the seafloor, a current position of the underwater vehicle, and a maximum and a minimum altitude above the seafloor.

6. The method according to claim 1, wherein the predicted trajectory of the underwater vehicle comprises a plurality of points, the determining step comprises the steps of:
calculating altitude differences between multiple points of the predicted trajectory of the underwater vehicle and corresponding points on the seafloor of the underwater region;
determining a relationship between each of the altitude differences and a target altitude range.

7. The method according to claim 6, wherein the target altitude range is defined by a maximum altitude and a minimum altitude,
the determining step comprises determining that the altitude differences are smaller than the maximum altitude and larger than the minimum altitude,
the controlling step comprises allowing the underwater vehicle to travel along the current path.

8. The method according to claim 6, wherein the target altitude range is defined by a maximum altitude and a minimum altitude,
the determining step comprises determining that one or more of the altitude differences is larger than the maximum altitude;
the controlling step comprises decreasing the altitude of the one or more points, of the predicted trajectory of underwater vehicle, with altitude differences larger than the maximum altitude.

9. The method according to claim 6, wherein the target altitude range is defined by a maximum altitude and a minimum altitude,
the determining step comprises determining that one or more of the altitude differences is smaller than the minimum altitude;
the controlling step comprises changing route of the underwater vehicle or stopping the underwater vehicle.

10. The method according to claim 1, wherein the underwater vehicle is a towed vehicle, the control step is performed via an in-or out-movement of a cable connecting the towed vehicle to the vessel.

11. The method according to 1, wherein the underwater vehicle is a remotely operated underwater vehicle, ROV, the control step is performed by sending a command to the ROV, via a tether connecting the ROV to the vessel.

12. The method according to claim 1, wherein the predicted trajectory of the underwater vehicle comprises a plurality of points, the determining step comprises the steps of:
calculating a slope of first and a second point following a current point on the predicted trajectory of the underwater vehicle;
determining that the slope is larger than an upslope threshold;
the controlling step comprises replacing an altitude of the second point following the current point on the predicted trajectory of the underwater vehicle with an altitude calculated based on the upslope threshold.

13. The method according to 1, wherein the predicted trajectory of the underwater vehicle comprises a plurality of points, the determining step comprises the steps of:
calculating a slope of first and a second point following a current point on the predicted trajectory of the underwater vehicle;
determining that the slope is smaller than a downslope threshold;
the controlling step comprises replacing an altitude of the second point following the current point on the predicted trajectory of the underwater vehicle with an altitude calculated based on the downslope threshold.

14. A device for controlling an underwater vehicle moving along a travel trajectory, movement of the underwater vehicle being dependent on a vessel connected thereto, the device comprising a processor configured to:
obtain a topography of an underwater region where the underwater vehicle travels;
obtain a predicted trajectory of the underwater vehicle;
determine a relationship between the predicted trajectory of the underwater vehicle and a seafloor represented by the topography of the underwater region; and
control the underwater vehicle based on the determined relationship,
wherein the topography of the underwater region is linkable to a coordinate system of the travel trajectory of the underwater vehicle.

15. A computer program product, comprising a computer readable storage medium storing instructions which, when executed on at least one processor, cause the at least one processor to:
obtain a topography of an underwater region where the underwater vehicle travels;
obtain a predicted trajectory of the underwater vehicle;
determine a relationship between the predicted trajectory of the underwater vehicle and a seafloor represented by the topography of the underwater region; and
control the underwater vehicle based on the determined relationship,
wherein the topography of the underwater region is linkable to a coordinate system of the travel trajectory of the underwater vehicle.

16. The device according to claim 14, wherein the topography of the underwater region is obtained based on at least one of:
a measurement by a multibeam system on the vessel connected to the underwater vehicle;
a sonar system provided on the underwater vehicle;
an optical distance measuring device provided on the underwater vehicle; and
historical seafloor information of the underwater region.

17. The device according to claim 14, wherein the predicted trajectory of the underwater vehicle is obtained based on a pre-programmed route or via an extrapolation of a current travel trajectory of the underwater vehicle.

18. The device according to claim 14, wherein the pre-programmed route is obtained from a mission planner or by flying the underwater vehicle over defined coordinates.

19. The device according to claim 14, wherein the predicted trajectory of the underwater vehicle is obtained based on at least one of a target distance to the seafloor, a current position of the underwater vehicle, and a maximum and a minimum altitude above the seafloor.

20. The device according to claim 14, wherein the predicted trajectory of the underwater vehicle comprises a plurality of points, and the processor further configured to:
calculate altitude differences between multiple points of the predicted trajectory of the underwater vehicle and corresponding points on the seafloor of the underwater region;
determine a relationship between each of the altitude differences and a target altitude range.
